(19) United States
(12) Patent Application Publication
(10) Pub. No.: US 2025/0030627 A1
(43) Pub. Date: Jan. 23, 2025

(54) SYSTEM AND METHOD FOR FACILITATING EFFICIENT LOAD BALANCING IN A NETWORK INTERFACE CONTROLLER (NIC)

(71) Applicant: Hewlett Packard Enterprise Development LP, Spring, TX (US)

(72) Inventors: David Charles Hewson, Bristol (GB); Partha Kundu, Palo Alto, CA (US)

(21) Appl. No.: 18/907,686

(22) Filed: Oct. 7, 2024

Related U.S. Application Data
(63) Continuation of application No. 17/594,543, filed on Oct. 21, 2021, now Pat. No. 12,132,648.
(60) Provisional application No. 62/852,289, filed on May 23, 2019.
(60) Provisional application No. 62/852,273, filed on May 23, 2019.
(60) Provisional application No. 62/852,203, filed on May 23, 2019.

(51) Int. Cl. H04L 45/28; G06F 9/50; G06F 9/54; G06F 12/0862; G06F 12/1036; G06F 12/1045; G06F 13/14; G06F 13/16; G06F 13/28; G06F 13/38; G06F 13/40; G06F 13/42; G06F 15/173; H04L 1/00; H04L 43/0876; H04L 43/10; H04L 45/00; H04L 45/02; H04L 45/021; H04L 45/028; H04L 45/12; H04L 45/122; H04L 45/125; H04L 45/16; H04L 45/24; H04L 45/42; H04L 45/745; H04L 45/7453; H04L 47/10; H04L 47/11; H04L 47/12; H04L 47/122; H04L 47/20; H04L 47/22; H04L 47/24; H04L 47/2441; H04L 47/2466; H04L 47/2483; H04L 47/30; H04L 47/32; H04L 47/34; H04L 47/52; H04L 47/62; H04L 47/625; H04L 47/6275; H04L 47/629; H04L 47/76; H04L 47/762; H04L 47/78; H04L 47/80; H04L 49/00; H04L 49/101; H04L 49/15; H04L 49/90; H04L 49/9005; H04L 49/9047; H04L 67/1097; H04L 69/22; H04L 69/28; H04L 69/40

(52) U.S. Cl. CPC H04L 45/28; G06F 9/505; G06F 9/546; G06F 12/0862; G06F 12/1036; G06F 12/1063; G06F 13/14; G06F 13/16; G06F 13/1642; G06F 13/1673; G06F 13/1689; G06F 13/28; G06F 13/385; G06F 13/4022; G06F 13/4068; G06F 13/4221; G06F 15/17331; H04L 1/0083; H04L 43/0876; H04L 43/10; H04L 45/02; H04L 45/021; H04L 45/028; H04L 45/122; H04L 45/123; H04L 45/125; H04L 45/16; H04L 45/20; H04L 45/22; H04L 45/24; H04L 45/38; H04L 45/42; H04L 45/46; H04L 45/566; H04L 45/70; H04L 45/745; H04L 45/7453; H04L 47/11; H04L 47/12; H04L 47/122; H04L 47/18; H04L 47/20; H04L 47/22; H04L 47/24; H04L 47/2441; H04L 47/2466; H04L 47/2483; H04L 47/30; H04L 47/32; H04L 47/323; H04L 47/34; H04L 47/39; H04L 47/52; H04L 47/621; H04L 47/6235; H04L 47/626; H04L 47/6275; H04L 47/629; H04L 47/76; H04L 47/762; H04L 47/781; H04L 47/80; H04L 49/101; H04L 49/15; H04L 49/30; H04L 49/3009; H04L 49/3018; H04L 49/3027; H04L 49/90; H04L 49/9005; H04L 49/9021; H04L 49/9036; H04L 49/9047; H04L 67/1097; H04L 69/22; H04L 69/40; G06F 2212/50; G06F 2213/0026; G06F 2213/3808; H04L 69/28

(57) ABSTRACT

A network interface controller (NIC) capable of efficient load balancing among the hardware engines is provided. The NIC can be equipped with a plurality of ordering control units (OCUs), a queue, a selection logic block, and an allocation logic block. The selection logic block can determine, from the plurality of OCUs, an OCU for a command from the queue, which can store one or more commands. The allocation logic block can then determine a selection setting for the OCU, select an egress queue for the command based on the selection setting, and send the command to the egress queue.

### CROSS-REFERENCE TO RELATED APPLICATIONS

This application is a continuation of and claims the priority benefit of U.S. patent application Ser. No. 17/594,543, filed on Oct. 21, 2021, which is a 371 National Stage Entry of PCT/US2020/024272, filed on Mar. 23, 2020, which claims the benefit of and priority to U.S. Provisional Patent Application No. 62/852,203, filed on May 23, 2019, U.S. Provisional Patent Application No. 62/852,273, filed on May 23, 2019, and U.S. Provisional Patent Application No. 62/852,289, filed on May 23, 2019, the contents of which are incorporated herein by reference in their entirety

### BACKGROUND

### Field

This is generally related to the technical field of networking. More specifically, this disclosure is related to systems and methods for facilitating efficient load balancing among the hardware engines in a network interface controller (NIC).

### Related Art

As network-enabled devices and applications become progressively more ubiquitous, various types of traffic as well as the ever-increasing network load continue to demand more performance from the underlying network architecture. For example, applications such as high-performance computing (HPC), media streaming, and Internet of Things (IoT) can generate different types of traffic with distinctive characteristics. As a result, in addition to conventional network performance metrics such as bandwidth and delay, network architects continue to face challenges such as scalability, versatility, and efficiency.

### SUMMARY

A network interface controller (NIC) capable of efficient load balancing among the hardware engines is provided. The NIC can be equipped with a plurality of ordering control units (OCUs), a queue, a selection logic block, and an allocation logic block. The selection logic block can determine, from the plurality of OCUs, an OCU for a command from the queue, which can store one or more commands. The allocation logic block can then determine a selection setting for the OCU, select a flow queue for the command based on the selection setting, and send the command to the flow queue.

### BRIEF DESCRIPTION OF THE FIGURES

FIG. 1 shows an exemplary network.

FIG. 2A shows an exemplary NIC chip with a plurality of NICs.

FIG. 2B shows an exemplary architecture of a NIC.

FIG. 3 shows efficient load balancing among the hardware engines in a NIC.

FIG. 4A shows a flow chart of a process of efficient load balancing for unordered commands in a NIC.

FIG. 4B shows a flow chart of a process of efficient load balancing for ordered commands in a NIC.

FIG. 5 shows an exemplary computer system equipped with a NIC that facilitates efficient load balancing among the hardware engines.

In the figures, like reference numerals refer to the same figure elements.

### DETAILED DESCRIPTION

Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown.

### Overview

The present disclosure describes systems and methods that facilitate efficient load balancing among the hardware engines in a network interface controller (NIC). The NIC allows a host to communicate with a data-driven network.

The embodiments described herein solve the problem of efficiently distributing load in a NIC for a combination of ordered and unordered commands by (i) distributing the load among a set of ordering control units (OCUs), and (ii) dynamically mapping a respective OCU to a corresponding forwarding hardware unit.

During operation, the NIC may process a command that may perform an operation on the memory of the host device (e.g., a “GET” or a “PUT” command of remote direct memory access (RDMA)). A host interface of the NIC may couple the NIC with the host device and facilitate the communication between the memory of the host device and the NIC. Applications running on the host device may submit commands to the NIC via the host interface. These commands can then be executed concurrently by a number of hardware engines of the NIC. These hardware engines can be specialized accelerators for processing direct memory access (DMA) commands. The commands can be retrieved from respective command queues and distributed among the hardware engines for processing.

A subset of the commands can be ordered. The NIC should execute these ordered commands in order. The rest of the commands can be unordered and hence, can be executed out of order. Typically, the NIC may apply a hash function to a command to determine a hash value and allocate the command to a hardware engine corresponding to the hash value. Applying the hash function on the ordered commands can generate the same hash value. Consequently, if the hash function is used to select among a small set of hardware engines, the NIC may repeatedly select a particular hardware engine while another hardware engine may remain underutilized. As a result, the level of concurrency can be adversely affected, thereby leading to reduced performance of the NIC and the switch fabric coupling the NIC.

To solve this problem, the NIC can be equipped with a set of OCUs that can be the target of the hash function. The OCUs can allow the NIC to facilitate a dynamic load balancing mechanism such that the ordered commands remain ordered while being evenly balanced among the hardware engines. A respective hardware engine can be associated with one or more flow queues and forwarding hardware. The forwarding hardware can include an egress queue (e.g., an outgoing buffer for sending a packet). A respective hardware engine can obtain the commands from the one or more flow queues allocated to that hardware engine for processing. The OCUs can form an intermediate layer between the command queues and the flow queues.

The NIC may use the hash function to allocate commands to the OCUs. However, since the number of OCUs can be significantly larger than the number of hardware engines, the distribution of the commands among the OCUs can be balanced. Subsequently, the NIC may dynamically select a flow queue based on the load of the flow queues. For example, the NIC may select a flow queue that has a load below a threshold or a flow queue with the least amount of load. In this way, the OCUs can be dynamically mapped to the hardware engines by selecting the least loaded hardware engine. Once selected, the same hardware engine can be used for a set of ordered commands.

Since different applications may generate different flows of ordered commands, the NIC may allocate a respective flow of ordered commands to a distinct flow queue. Once the execution of a particular flow of ordered commands is completed, the NIC may release the flow queue for subsequent allocation and remapping. Applying the hash function across a large number of OCUs and dynamic load-based selection of the flow queues can facilitate efficient load distribution among the corresponding hardware engines. In this way, the NIC can facilitate efficient load balancing among forwarding engines and may improve the performance of the NIC and the switch fabric coupling the NIC.

One embodiment of the present invention provides a NIC that can be equipped with a plurality of ordering control units (OCUs), a queue, a selection logic block, and an allocation logic block. The selection logic block can determine, from the plurality of OCUs, an OCU for a command from the queue, which can store one or more commands. The allocation logic block can then determine a selection setting for the OCU, select an egress queue for the command based on the selection setting, and send the command to the egress queue.

In a variation on this embodiment, the egress queue can be a flow queue. The allocation logic block can then determine whether the selection setting indicates a static flow queue allocation for the OCU. If the selection setting indicates a static flow queue allocation, the allocation logic block can select the flow queue based on the static allocation.

In a further variation, if the selection setting indicates a dynamic flow queue allocation, the allocation logic block can dynamically select the flow queue from a set of flow queues associated with the OCU based on the load on a respective flow queue.

In a further variation, the OCU can be in a set of OCUs, and the set of flow queues can be associated with the set of OCUs.

In a further variation, the allocation logic block can reallocate the flow queue if a respective command in the flow queue has been processed.

In a variation on this embodiment, the selection logic block may determine the OCU by one or more of: (i) determining the OCU based on an indicator in the command, and (ii) determining a hash value by applying a hash function on the command and identifying the OCU based on the hash value.

In a variation on this embodiment, the allocation logic block can determine that the command is an ordered command.

In a further variation, the allocation logic block can determine whether the command is an initial command of a flow of ordered commands. If the command is not the initial command, the allocation logic block can select the egress queue based on a previous selection for another command in the flow of ordered commands.

In a variation on this embodiment, if the command is an unordered command, the allocation logic block can set a predefined value as an identifier for the OCU. The predefined value may indicate that the command is unordered.

In a variation on this embodiment, the allocation logic block can maintain a number of commands associated with the OCU.

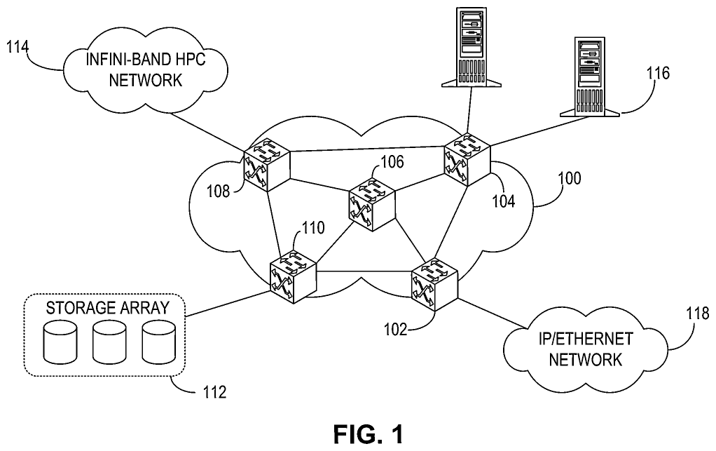

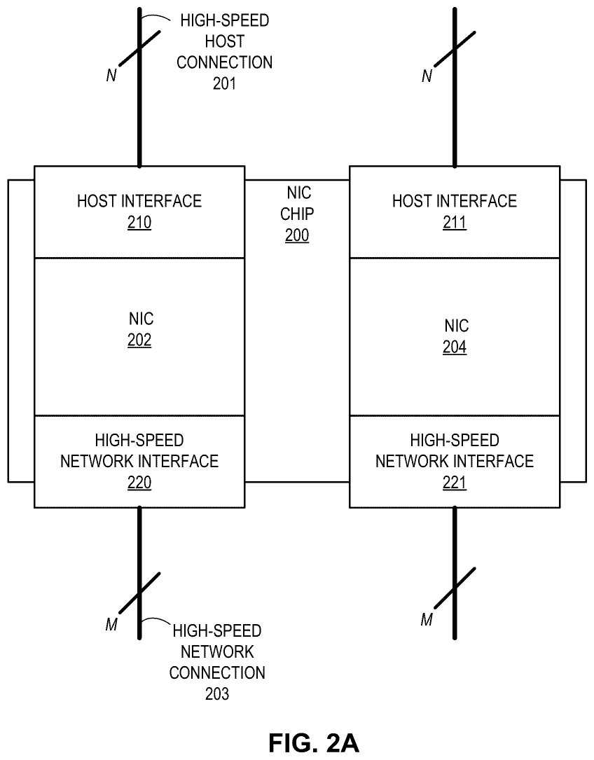

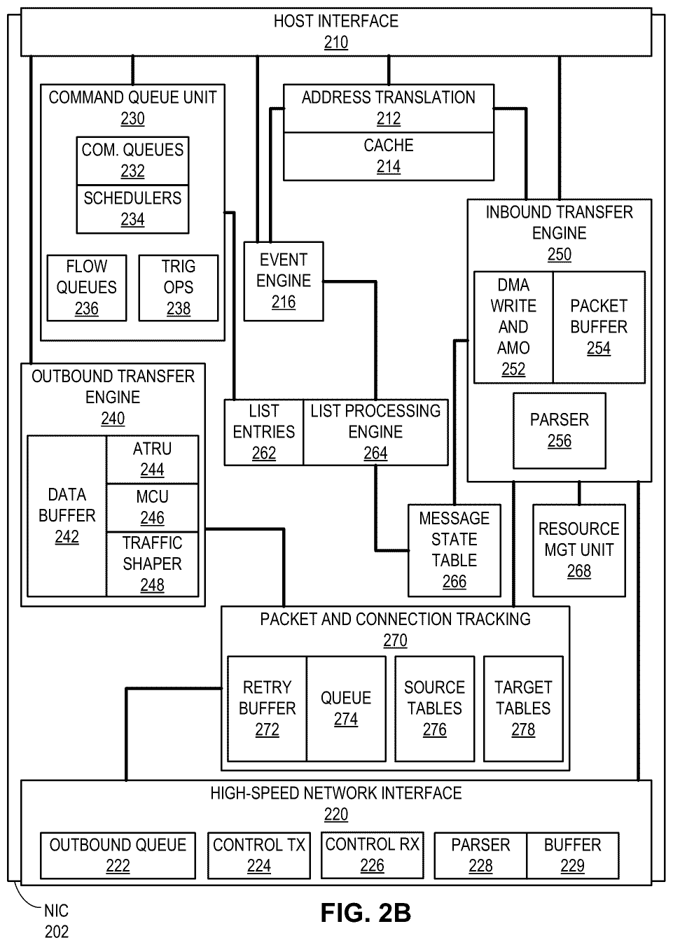

In this disclosure, the description in conjunction with FIG. 1 is associated with the network architecture and the description in conjunction with FIG. 2A and onward provide more details on the architecture and operations associated with a NIC that supports efficient management of idempotent operations.

FIG. 1 shows an exemplary network. In this example, a network 100 of switches, which can also be referred to as a “switch fabric,” can include switches 102, 104, 106, 108, and 110. Each switch can have a unique address or ID within switch fabric 100. Various types of devices and networks can be coupled to a switch fabric. For example, a storage array 112 can be coupled to switch fabric 100 via switch 110; an InfiniBand (IB) based HPC network 114 can be coupled to switch fabric 100 via switch 108; a number of end hosts, such as host 116, can be coupled to switch fabric 100 via switch 104; and an IP/Ethernet network 118 can be coupled to switch fabric 100 via switch 102. In general, a switch can have edge ports and fabric ports. An edge port can couple to a device that is external to the fabric. A fabric port can couple to another switch within the fabric via a fabric link. Typically, traffic can be injected into switch fabric 100 via an ingress port of an edge switch, and leave switch fabric 100 via an egress port of another (or the same) edge switch. An ingress link can couple a NIC of an edge device (for example, an HPC end host) to an ingress edge port of an edge switch. Switch fabric 100 can then transport the traffic to an egress edge switch, which in turn can deliver the traffic to a destination edge device via another NIC.

### Exemplary NIC Architecture

FIG. 2A shows an exemplary NIC chip with a plurality of NICs. With reference to the example in FIG. 1, a NIC chip 200 can be a custom application-specific integrated circuit (ASIC) designed for host 116 to work with switch fabric 100. In this example, chip 200 can provide two independent NICs 202 and 204. A respective NIC of chip 200 can be equipped with a host interface (HI) (e.g., an interface for connecting to the host processor) and one High-speed Network Interface (HNI) for communicating with a link coupled to switch fabric 100 of FIG. 1. For example, NIC 202 can include an HI 210 and an HNI 220, and NIC 204 can include an HI 211 and an HNI 221.

In some embodiments, HI 210 can be a peripheral component interconnect (PCI), a peripheral component interconnect express (PCIe), or a compute express link (CXL) interface. HI 210 can be coupled to a host via a host connection 201, which can include N (e.g., N can be 16 in some chips) PCIe Gen 4 lanes capable of operating at signaling rates up to 25 Gbps per lane. HNI 210 can facilitate a high-speed network connection 203, which can communicate with a link in switch fabric 100 of FIG. 1. HNI 210 can operate at aggregate rates of either 100 Gbps or 200 Gbps using M (e.g., M can be 4 in some chips) full-duplex serial lanes. Each of the M lanes can operate at 25 Gbps or 50 Gbps based on non-return-to-zero (NRZ) modulation or pulse amplitude modulation 4 (PAM4), respectively. HNI 220 can support the Institute of Electrical and Electronics Engineers (IEEE) 802.3 Ethernet-based protocols as well as an enhanced frame format that provides support for higher rates of small messages.

NIC 202 can support one or more of: point-to-point message passing based on Message Passing Interface (MPI), remote memory access (RMA) operations, offloading and progression of bulk data collective operations, and Ethernet packet processing. When the host issues an MPI message, NIC 202 can match the corresponding message type. Furthermore, NIC 202 can implement both eager protocol and rendezvous protocol for MPI, thereby offloading the corresponding operations from the host.

Furthermore, the RMA operations supported by NIC 202 can include PUT, GET, and Atomic Memory Operations (AMO). NIC 202 can provide reliable transport. For example, if NIC 202 is a source NIC, NIC 202 can provide a retry mechanism for idempotent operations. Furthermore, connection-based error detection and retry mechanism can be used for ordered operations that may manipulate a target state. The hardware of NIC 202 can maintain the state necessary for the retry mechanism. In this way, NIC 202 can remove the burden from the host (e.g., the software). The policy that dictates the retry mechanism can be specified by the host via the driver software, thereby ensuring flexibility in NIC 202.

Furthermore, NIC 202 can facilitate triggered operations, a general-purpose mechanism for offloading, and progression of dependent sequences of operations, such as bulk data collectives. NIC 202 can support an application programming interface (API) (e.g., libfabric API) that facilitates fabric communication services provided by switch fabric 100 of FIG. 1 to applications running on host 116. NIC 202 can also support a low-level network programming interface, such as Portals API. In addition, NIC 202 can provide efficient Ethernet packet processing, which can include efficient transmission if NIC 202 is a sender, flow steering if NIC 202 is a target, and checksum computation. Moreover, NIC 202 can support virtualization (e.g., using containers or virtual machines).

FIG. 2B shows an exemplary architecture of a NIC. In NIC 202, the port macro of HNI 220 can facilitate low-level Ethernet operations, such as physical coding sublayer (PCS) and media access control (MAC). In addition, NIC 202 can provide support for link layer retry (LLR). Incoming packets can be parsed by parser 228 and stored in buffer 229. Buffer 229 can be a PFC Buffer provisioned to buffer a threshold amount (e.g., one microsecond) of delay bandwidth. HNI 220 can also include control transmission unit 224 and control reception unit 226 for managing outgoing and incoming packets, respectively.

NIC 202 can include a Command Queue (CQ) unit 230. CQ unit 230 can be responsible for fetching and issuing host side commands. CQ unit 230 can include command queues 232 and schedulers 234. Command queues 232 can include two independent sets of queues for initiator commands (PUT, GET, etc.) and target commands (Append, Search, etc.), respectively. Command queues 232 can be implemented as circular buffers maintained in the memory of NIC 202. Applications running on the host can write to command queues 232 directly. Schedulers 234 can include two separate schedulers for initiator commands and target commands, respectively. The initiator commands are sorted into flow queues 236 based on a hash function. One of flow queues 236 can be allocated to a unique flow. Furthermore, CQ unit 230 can further include a triggered operations module 238, which is responsible for queuing and dispatching triggered commands.

Outbound transfer engine (OXE) 240 can pull commands from flow queues 236 in order to process them for dispatch. OXE 240 can include an address translation request unit (ATRU) 244 that can send address translation requests to address translation unit (ATU) 212. ATU 212 can provide virtual to physical address translation on behalf of different engines, such as OXE 240, inbound transfer engine (IXE) 250, and event engine (EE) 216. ATU 212 can maintain a large translation cache 214. ATU 212 can either perform translation itself or may use host-based address translation services (ATS). OXE 240 can also include message chopping unit (MCU) 246, which can fragment a large message into packets of sizes corresponding to a maximum transmission unit (MTU). MCU 246 can include a plurality of MCU modules. When an MCU module becomes available, the MCU module can obtain the next command from an assigned flow queue. The received data can be written into data buffer 242. The MCU module can then send the packet header, the corresponding traffic class, and the packet size to traffic shaper 248. Shaper 248 can determine which requests presented by MCU 246 can proceed to the network.

Subsequently, the selected packet can be sent to packet and connection tracking (PCT) 270. PCT 270 can store the packet in a queue 274. PCT 270 can also maintain state information for outbound commands and update the state information as responses are returned. PCT 270 can also maintain packet state information (e.g., allowing responses to be matched to requests), message state information (e.g., tracking the progress of multi-packet messages), initiator completion state information, and retry state information (e.g., maintaining the information required to retry a command if a request or response is lost). If a response is not returned within a threshold time, the corresponding command can be stored in retry buffer 272. PCT 270 can facilitate connection management for initiator and target commands based on source tables 276 and target tables 278, respectively. For example, PCT 270 can update its source tables 276 to track the necessary state for reliable delivery of the packet and message completion notification. PCT 270 can forward outgoing packets to HNI 220, which stores the packets in outbound queue 222.

NIC 202 can also include an IXE 250, which provides packet processing if NIC 202 is a target or a destination. IXE 250 can obtain the incoming packets from HNI 220. Parser 256 can parse the incoming packets and pass the corresponding packet information to a List Processing Engine (LPE) 264 or a Message State Table (MST) 266 for matching. LPE 264 can match incoming messages to buffers. LPE 264 can determine the buffer and start address to be used by each message. LPE 264 can also manage a pool of list entries 262 used to represent buffers and unexpected messages. MST 266 can store matching results and the information required to generate target side completion events. MST 266 can be used by unrestricted operations, including multi-packet PUT commands, and single-packet and multi-packet GET commands.

Subsequently, parser 256 can store the packets in packet buffer 254. IXE 250 can obtain the results of the matching for conflict checking. DMA write and AMO module 252 can then issue updates to the memory generated by write and AMO operations. If a packet includes a command that generates target side memory read operations (e.g., a GET response), the packet can be passed to the OXE 240. NIC 202 can also include an EE 216, which can receive requests to generate event notifications from other modules or units in NIC 202. An event notification can specify that either a fill event or a counting event is generated. EE 216 can manage event queues, located within host processor memory, to which it writes full events. EE 216 can forward counting events to CQ unit 230.

### Efficient Load Balancing in NIC

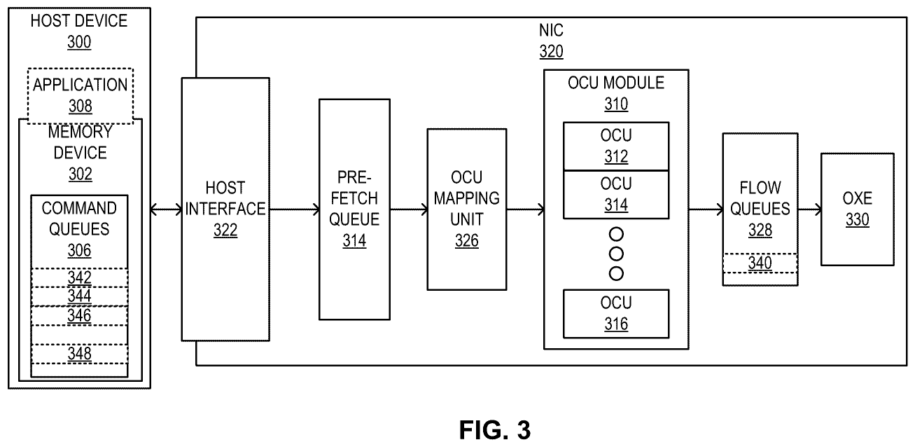

FIG. 3 shows efficient load balancing among the hardware engines in a NIC. In this example, host device 300 can include a NIC 320. An HI 322 of NIC 320 may couple NIC 320 with device 300 and facilitate the communication between device 300 and NIC 320. Device 300 can include a memory device 302 (e.g., a dynamic random-access memory (DRAM) module). An application 308 may issue commands for memory access (e.g., a DMA GET or PUT). Host device 300 may store the commands in a command queue of command queues 306 in memory device 302. NIC 320 may obtain the commands from command queues 306 via HI 322 and distribute the commands among the hardware engines of NIC 320 for processing. A respective hardware engine may be distributed across multiple operational units of NIC 320, such as OXE 330 (e.g., an MCU and a traffic shaper). NIC 320 can concurrently execute the commands using the hardware engines.

A subset of the commands in command queues 306 can be ordered. NIC 320 should execute these ordered commands in order. The rest of the commands in command queues 306 can be unordered and hence, can be executed out of order. Typically, NIC 320 may apply a hash function to a command to determine a hash value and allocate the command to a hardware engine corresponding to the hash value. Applying the hash function to ordered commands 342, 344, and 346 can generate the same hash value. Consequently, if the hash function is used to select among a small set of hardware engines, NIC 320 may repeatedly select a particular hardware engine while another hardware engine may remain underutilized. As a result, the level of concurrency can be adversely affected, thereby leading to reduced performance in NIC 320.

To solve this problem, NIC 320 can be equipped with an OCU module 310 that can include a number of OCUs 312, 314, and 316. NIC 320 can also include an OCU mapping unit (OMU) 326 that can facilitate a hash function for selecting an OCU from OCU module 310. OCU module 310 can allow NIC 320 to facilitate a dynamic load balancing mechanism such that ordered commands 342, 344, and 346 remain ordered while being evenly balanced among the hardware engines. NIC 320 can also include a set of flow queues 328. A respective hardware engine can be associated with one or more flow queues and forwarding hardware. The forwarding hardware can include an egress queue. A respective hardware engine may obtain the commands from the one or more flow queues allocated to that hardware engine for processing. OCU module 310 can form an intermediate layer between command queues 306 and flow queues 328. NIC 320 can obtain commands 342, 344, and 346 from command queues 306 and store these commands in a pre-fetch queue 324.

OMU 326 can then apply the hash function to command 342 in pre-fetch queue 324. Upon obtaining the hash value, OMU 326 can determine which OCU that hash value corresponds to. Command 342 may also specify the OCU it should be allocated to. If the hash value corresponds to OCU 312, OMU 326 can allocate command 342 to OCU 312. However, since the number of OCUs can be significantly larger than the number of hardware engines, the distribution of the commands among OCUs in OCU module 310 can be balanced. Subsequently, NIC 320 may dynamically select a flow queue 340 for command 342 based on the load of flow queues 328. Flow queue 340 can have a load below a threshold or the least amount of load. In this way, OCU 312 can be dynamically mapped to the hardware engine associated with flow queue 340. Once selected, the same hardware engine can be used for commands 344 and 346 since the hash function of OMU 326 can select OCU 312 for these commands.

Since different applications may generate different flows of ordered commands, NIC 320 may allocate a respective flow of ordered commands to a distinct flow queue. For example, the flow comprising commands 342, 344, and 346 can be allocated to flow queue 340, while another flow of commands can be allocated to another flow queue. Once the execution of commands 342, 344, and 346 is completed, OMU 326 may release flow queue 340 for subsequent allocation and remapping. Furthermore, OMU 326 may remap OCU 312 when commands 342 and 344 are completed, and command 346 is being processed. This allows OMU 326 to release and reallocate OCU 312 as soon the last command of a flow of commands has been processed (e.g., enters flow queue 328 or is processed by OXE 330). Applying the hash function across a large number of OCUs in OCU module 310 and dynamic load-based selection of a flow queue from flow queues 328 can facilitate efficient load distribution among the corresponding hardware engines in NIC 320, thereby improving the performance of NIC 320.

The OCUs in OCU module 310 can be divided into a number of OCU sets (OCUSETs). Resources associated with NIC 320, such as command queues 306, pre-fetch queue 324, and flow queues 328, can be allocated to an OCUSET. A respective OCU in an OCUSET can share the resources associated with the OCUSET. For example, if OCUs 312 and 314 belong to the same OCUSET, OCUs 312 and 314 can share the resources, such as flow queue 340, that belong to the OCUSET. An OCUSET mapping table in NIC 320 can indicate which OCU belongs to which OCUSET. Each OCUSET can include a distinct set of OCUs. Furthermore, a flow queue mapping table can determine which flow queues are allocated to an OCUSET based on respective flow queue identifiers. Multiple OCUSETs can be mapped to the same flow queue.

A respective OCU, such as OCU 312, can represent a flow of ordered commands 342, 344, and 346. All ordered commands from a certain command queue should be allocated to the same OCU. It should be noted that commands from different command queues of command queues 306 may be allocated to the same OCU. However, when commands from multiple commands queues are allocated to the same OCU, NIC 320 may consider the commands as parts of the same flow of commands. Consequently, each OCU is mapped to a flow queue, and the ordered commands associated with that OCU should enter the same flow queue. For example, since commands 342, 344, and 346 are mapped to OCU 312, each of these commands can be forwarded to flow queue 340.

If there are no outstanding commands for OCU 312 in flow queue 340, NIC 320 may map OCU 312 to a different flow queue based on the load. An unordered command 348 can be allocated to any flow queue belonging to the OCUSET associated with the command. The association between command 348 and its OCUSET can be determined based on the command queue of command 348. In other words, command 348 can be associated with the OCUSET that is associated with the command queue of command 348. The selection of a flow queue can be dictated by a selection setting. Based on the selection setting, the NIC can select the flow by dynamically allocating the flow queue based on the load or statically allocating the flow queue by mapping an OCU to a flow queue (e.g., based on user configuration).

A command associated with an OCU can only be forwarded to the flow queues within its OCUSET. Hence, for each OCUSET, NIC 320 may maintain a number or count of flow queues available to the OCUSET and a current least-load value among the flow queues assigned to the OCUSET. OMU 326 can compute a load metric when for assigning command 342 to flow queue 340. The load metric can be computed from the command that is forwarded to OXE 330 and a command load determined by OXE 330. NIC 320 can maintain a number of values, such as header, scale, and shift, associated with a respective class of traffic. These values can be stored in corresponding registers (e.g., control and status registers (CSRs)). NIC 320 can use the length of a command and the values in the CSRs to determine the load.

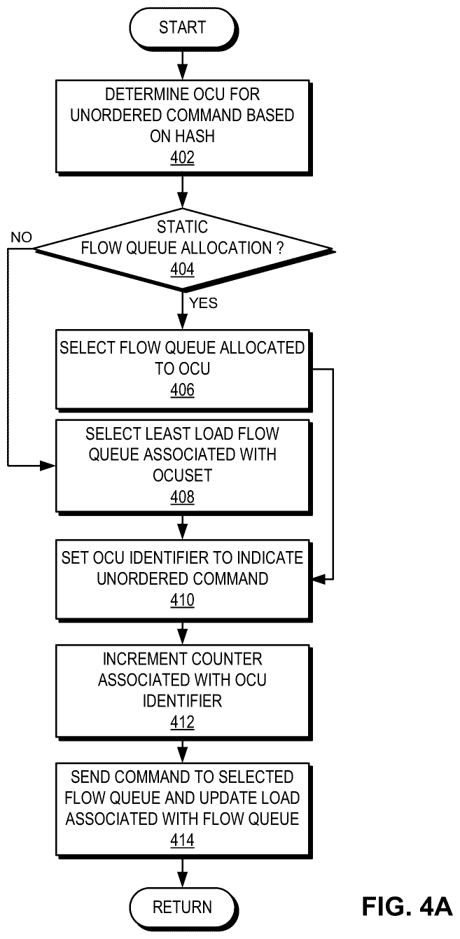

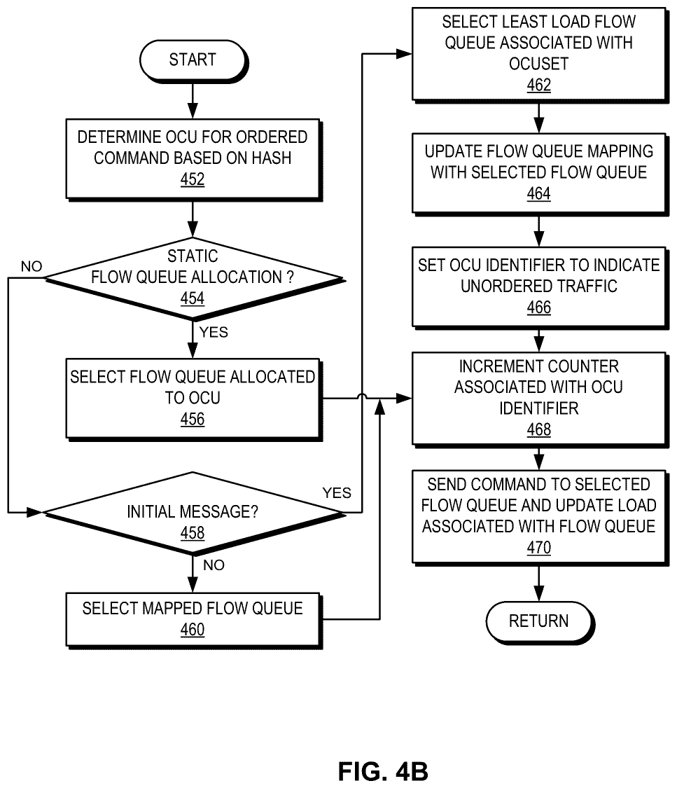

FIG. 4A shows a flow chart of a process of efficient load balancing for unordered commands in a NIC. During operation, the NIC can determine an OCU for an unordered command based on a hash (operation 402) and determine whether the flow queue allocation is static for the OCU (operation 404). If the flow queue allocation is static for the OCU, the NIC can select the flow queue allocated to the OCU (operation 406). On the other hand, if the flow queue allocation is not static (i.e., dynamic), the NIC can select the least load flow queue associated with the OCUSET (operation 408).

Upon selecting a flow queue (operation 406 or 408), the NIC can set an OCU identifier to indicate that the command is an unordered command (operation 410). It should be noted that, since an unordered command can be allocated to any flow queue associated with an OCUSET, a predefined value (e.g., N−1, where N is the number of OCUs in the NIC) can be set as the OCU identifier. Setting the predefined value may notify the flow queue that the command can be delivered out of order. The NIC can then increment a counter (e.g., a message counter) associated with the OCU identifier (operation 412), and send the command to the selected flow queue and update the load associated with the flow queue (operation 414).

FIG. 4B shows a flow chart of a process of efficient load balancing for ordered commands in a NIC. During operation, the NIC can determine an OCU for an ordered command based on a hash (operation 452) and determine whether the flow queue allocation is static for the OCU (operation 454). If the flow queue allocation is static for the OCU, the NIC can select the flow queue allocated to the OCU (operation 456). On the other hand, if the flow queue allocation is not static (i.e., dynamic), the NIC can determine whether the received message is the initial message associated with the command (operation 458). If the message is not the initial message, the NIC can select an already mapped flow queue (operation 460).

On the other hand, if the message is the initial message, the NIC can select the least load flow queue associated with the OCUSET (operation 462). The NIC can then update the flow queue mapping with the selected flow queue (operation 464). The NIC can then set an OCU identifier to indicate that the command is an ordered command (operation 466). Upon selecting the static flow queue (operation 456) or the mapped flow queue (operation 460), or setting the OCU identifier (operation 466), the NIC can increment a counter (e.g., a message counter) associated with the OCU identifier (operation 468), and send command to the selected flow queue and update the load associated with the flow queue (operation 470).

### Exemplary Computer System

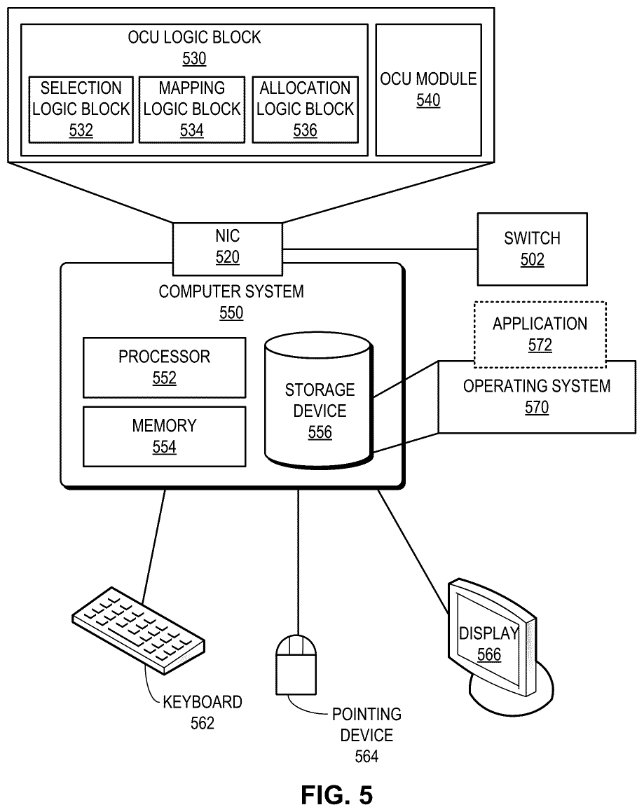

FIG. 5 shows an exemplary computer system equipped with a NIC that facilitates efficient packet forwarding. Computer system 550 includes a processor 552, a memory device 554, and a storage device 556. Memory device 554 can include a volatile memory device (e.g., a dual in-line memory module (DIMM)). Furthermore, computer system 550 can be coupled to a keyboard 562, a pointing device 564, and a display device 566. Storage device 556 can store an operating system 570. An application 572 can operate on operating system 570.

Computer system 550 can be equipped with a host interface coupling a NIC 520 that facilitates efficient data request management. NIC 520 can provide one or more HNIs to computer system 550. NIC 520 can be coupled to a switch 502 via one of the HNIs. NIC 520 can include an OCU logic block 530 (e.g., in the CQ unit of NIC 520). OCU logic block 530 can manage OCUs for NIC 520, and may include a selection logic block 532, a mapping logic block 534, and an allocation logic block 536.

Selection logic block 532 can select an OCU from OCU module 540 for a command based on a hash function. Mapping logic block 534 can update the OCUSET mapping table and the flow queue mapping table. Allocation logic block 536 can allocate a flow queue to an OCU based on static or dynamic allocation. The dynamic allocation can be based on a dynamic load balancing mechanism.

In summary, the present disclosure describes a NIC that facilitates efficient load balancing among the hardware engines in the NIC. The NIC can be equipped with a plurality of ordering control units (OCUs), a queue, a selection logic block, and an allocation logic block. The selection logic block can determine, from the plurality of OCUs, an OCU for a command from the queue, which can store one or more commands. The allocation logic block can then determine a selection setting for the OCU, select a flow queue for the command based on the selection setting, and send the command to the flow queue.

The methods and processes described above can be performed by hardware logic blocks, modules, logic blocks, or apparatus. The hardware logic blocks, modules, logic blocks, or apparatus can include, but are not limited to, application-specific integrated circuit (ASIC) chips, field-programmable gate arrays (FPGAs), dedicated or shared processors that execute a piece of code at a particular time, and other programmable-logic devices now known or later developed. When the hardware logic blocks, modules, or apparatus are activated, they perform the methods and processes included within them.

The methods and processes described herein can also be embodied as code or data, which can be stored in a storage device or computer-readable storage medium. When a processor reads and executes the stored code or data, the processor can perform these methods and processes.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A network interface controller (NIC), comprising:
a plurality of ordering control units (OCUs);
a queue to store one or more commands;
a selection logic block to determine, from the plurality of OCUs, an OCU for a command from the queue; and
an allocation logic block to:
determine a selection setting for the OCU;
select an egress queue for the command based on the selection setting; and
send the command to the egress queue.

2. The network interface controller of claim 1, wherein the egress queue is a flow queue, and wherein the allocation logic block is further to:
determine whether the selection setting indicates a static flow queue allocation for the OCU; and
in response to the selection setting indicating a static flow queue allocation, select the flow queue based on the static allocation.

3. The network interface controller of claim 2, wherein, in response to the selection setting indicating a dynamic flow queue allocation, the allocation logic block is further to dynamically select the flow queue from a set of flow queues associated with the OCU based on a load on a respective flow queue.

4. The network interface controller of claim 3, wherein the OCU is in a set of OCUs, and wherein the set of flow queues is associated with the set of OCUs.

5. The network interface controller of claim 2, wherein the allocation logic block is further to reallocate the flow queue in response to determining that a respective command in the flow queue has been processed.

6. The network interface controller of claim 1, wherein the selection logic block is further to determine the OCU by one or more of:
determining the OCU based on an indicator in the command; and
determining a hash value by applying a hash function on the command and identifying the OCU based on the hash value.

7. The network interface controller of claim 1, the allocation logic block is further to determine that the command is an ordered command.

8. The network interface controller of claim 6, wherein the allocation logic block is further to:
determine whether the command is an initial command of a flow of ordered commands; and
in response to the command not being the initial command, select the egress queue based on a previous selection for another command in the flow of ordered commands.

9. The network interface controller of claim 1, wherein, in response to determining that the command is an unordered command, the allocation logic block is further to set a predefined value as an identifier for the OCU, wherein the predefined value indicates that the command is unordered.

10. The network interface controller of claim 1, wherein the allocation logic block is further to maintain a number of commands associated with the OCU.

11. A method, comprising:
obtaining, from a queue in a network interface controller (NIC), a command, wherein the NIC comprises a plurality of ordering control units (OCUs);
determining, from the plurality of OCUs, an OCU for the command obtained from the queue;
determining a selection setting for the OCU;
selecting an egress queue for the command based on the selection setting; and
sending the command to the egress queue.

12. The method of claim 11, wherein the egress queue is a flow queue, and wherein the method further comprises:
determining whether the selection setting indicates a static flow queue allocation for the OCU; and
in response to the selection setting indicating a static flow queue allocation, selecting the flow queue based on the static allocation.

13. The method of claim 12, further comprising, in response to the selection setting indicating a dynamic flow queue allocation, dynamically selecting the flow queue from a set of flow queues associated with the OCU based on a load on a respective flow queue.

14. The method of claim 13, wherein the OCU is in a set of OCUs, and wherein the set of flow queues is associated with the set of OCUs.

15. The method of claim 12, further comprising reallocating the flow queue in response to determining that a respective command in the flow queue has been processed.

16. The method of claim 11, wherein determining the OCU further comprises one or more of:
determining the OCU based on an indicator in the command; and
determining a hash value by applying a hash function on the command and and identifying the OCU based on the hash value.

17. The method of claim 11, further comprising determining that the command is an ordered command.

18. The method of claim 16, further comprising:
determining whether the command is an initial command of a flow of ordered command; and
in response to the command not being the initial command, selecting the egress queue based on a previous selection for another command in the flow of ordered command.

19. The method of claim 11, further comprising, in response to determining that the command is an unordered command, setting a predefined value as an identifier for the OCU, wherein the predefined value indicates that the command is unordered.

20. The method of claim 11, further comprising maintaining a number of commands associated with the OCU.
